(19) United States
(12) Patent Application Publication
(10) Pub. No.: US 2026/0349068 A1
(43) Pub. Date: Nov. 5, 2026

(54) Systems and Methods for PNT using Ground-Based Reflectors

(71) Applicant: Thin Air Nav Corp, Phoenix, AZ (US)

(72) Inventor: Charles Justin ARMER, Bozeman, MT (US)

(73) Assignee: Thin Air Nav Corp, Phoenix, AZ (US)

(21) Appl. No.: 19/238,290

(22) Filed: Jun. 13, 2025

Related U.S. Application Data
(60) Provisional application No. 63/762,611, filed on Feb. 24, 2025.
(60) Provisional application No. 63/660,401, filed on Jun. 14, 2024.

(51) Int. Cl. G01S 5/10

(52) U.S. Cl. CPC G01S 5/10

(57) ABSTRACT

A navigation system for airborne platforms in GPS-denied environments is disclosed. The system includes a position, navigation, and timing (PNT) unit onboard an airborne vehicle configured to determine its own position by performing multilateration using round-trip time-of-flight (ToF) measurements with multiple unnetworked, expendable ground-based beacons. Each beacon operates independently, requires no synchronization or inter-beacon communication, and may self-locate using various means. The airborne PNT system initiates and completes the ranging cycle, enabling autonomous position computation without centralized infrastructure or persistent communication links. This architecture allows precise, resilient navigation using low-cost, disposable beacons even in contested or denied electromagnetic environments.

### CROSS-REFERENCE TO RELATED APPLICATIONS

This application claims the benefit of (1) U.S. Provisional Application No. 63/660,401, filed Jun. 14, 2024, entitled “Systems and Methods for PNT Using Expendable Ground-Based Beacons,” and (2) U.S. Provisional Application No. 63/762,611, filed Feb. 24, 2025, entitled “Systems and Methods for PNT using Ground-Based Reflectors of ADS-B Signals.”

The contents of each of the above referenced applications are hereby incorporated by reference in their entirety.

### TECHNICAL FIELD

Various aspects of the present disclosure relate generally to systems and methods for position, navigation and timing (PNT) and, more particularly, to systems and methods for PNT using ground-based reflectors.

### BACKGROUND

Position, navigation, and timing (PNT) systems are foundational for modern aviation and defense operations. Historically, the Global Positioning System (GPS) has served as the primary source of PNT information, offering global availability and high accuracy. However, GPS signals are inherently weak due to the long distances from orbiting satellites, making them susceptible to both jamming and spoofing in contested environments.

Alternatives to GPS-based navigation include multilateration (MLAT) and distance measuring systems such as TACAN and DME. These systems rely on measuring the time difference of arrival (TDOA) or round-trip travel time of RF signals between transmitters and receivers. However, a common architectural limitation among all existing multilateration systems is that the position of the aircraft is computed remotely—typically on the ground—using infrastructure-based receivers that track the airborne vehicle.

This architecture presents several problems for modern autonomous aircraft, particularly unmanned aerial vehicles (UAVs) operating in GPS-denied environments. These platforms require onboard awareness of their own position without dependence on persistent communication with a centralized control network. Additionally, existing MLAT and TACAN systems rely on fixed, permanent ground infrastructure that cannot be rapidly deployed or maintained in dynamic or hostile conditions.

The present disclosure addresses these limitations by introducing a novel system and method in which the airborne vehicle performs its own positioning solution using round-trip time-of-flight (ToF) measurements with expendable, autonomous, and unnetworked ground-based beacons. These beacons do not require synchronization with one another, nor do they require external power, data links, or network integration. As such, they may be rapidly deployed in high volumes, operate covertly with low probability of detection, and remain resilient even if compromised or destroyed.

This approach shifts the computational burden from the ground to the aircraft, allowing for a scalable and infrastructure-free navigation method that is uniquely suited for autonomous operations in contested or denied electromagnetic environments.

The present disclosure is directed to overcoming one or more of these above-referenced challenges.

### SUMMARY OF THE DISCLOSURE

According to certain aspects of the disclosure, systems, methods, and computer readable memory are disclosed for PNT using ground-based beacons.

In some cases, a positioning system may include: an airborne system equipped with an Automatic Dependent Surveillance-Broadcast (ADS-B) transmitter configured to emit ADS-B signals; a plurality of ground-based reflectors configured to receive the ADS-B signals and emit reflection signals; and a receiver on the airborne system configured to receive the reflection signals, wherein the positioning system is configured to calculate a position of the airborne system based on round-trip time of flight between emission of the ADS-B signals and reception of the reflection signals.

In some cases, a navigation system may include: an airborne system equipped with a position, navigation, and timing (PNT) system configured to emit first radio signals; a plurality of ground-based beacons configured to receive the first radio signals from the PNT system and emit second radio signals to the PNT system; wherein the PNT system is configured to receive the second radio signals, calculate the round-trip time of flight based on the first radio signals and the second radio signals, and determine a position of the airborne system based on the round-trip time of flight.

In some cases, a navigation system may include: an airborne system equipped with a position, navigation, and timing (PNT) system configured to emit first radio signals; a plurality of expendable ground-based beacons configured to receive the first radio signals from the PNT system and emit second radio signals to the PNT system; wherein the PNT system is configured to receive the second radio signals, calculate the round-trip time of flight based on the first radio signals and the second radio signals, and determine a position of the airborne system based on the round-trip time of flight.

Additional objects and advantages of the disclosed technology will be set forth in part in the description that follows, and in part will be apparent from the description, or may be learned by practice of the disclosed technology.

It is to be understood that both the foregoing general description and the following detailed description are exemplary and explanatory only and are not restrictive of the disclosed technology, as claimed.

### BRIEF DESCRIPTION OF THE DRAWINGS

The accompanying drawings, which are incorporated in and constitute a part of this specification, illustrate various exemplary aspects and together with the description, serve to explain the principles of the disclosed technology.

FIG. 1 illustrates an environment for position, navigation, and timing (PNT) using expendable ground-based beacons, according to aspects of the present disclosure.

FIG. 2 depicts the components of a PNT system and a beacon, according to aspects of the present disclosure.

FIG. 3 depicts a diagram of airborne vehicles using the PNT system with expendable beacons for multilateration in the presence of an interference system, according to aspects of the present disclosure.

FIG. 4 depicts a block diagram of a PNT system, according to aspects of the present disclosure.

FIG. 5 depicts a block diagram of an expendable ground-based beacon, according to aspects of the present disclosure.

FIG. 6 depicts a dataflow diagram of a navigation system using expendable ground-based beacons and a PNT system, according to aspects of the present disclosure.

FIG. 7 depicts a flowchart of a navigation method, according to aspects of the present disclosure.

FIG. 8 illustrates a positioning system utilizing ADS-B signals and ground reflectors, according to aspects of the present disclosure.

FIG. 9 depicts a positioning system utilizing satellite and ground-based positioning capabilities, according to an embodiment.

FIG. 11 depicts an example system that may execute techniques presented herein.

### DETAILED DESCRIPTION

The present disclosure describes a navigation system specifically designed to enable airborne platforms—particularly unmanned aerial vehicles (UAVs)—to autonomously determine their own position in GPS-denied or contested environments. Unlike traditional multilateration (MLAT) or TACAN systems, which rely on centralized ground-based computation and fixed infrastructure, the disclosed system performs position computation onboard the airborne vehicle using round-trip time-of-flight (ToF) ranging with multiple expendable ground-based beacons.

The airborne platform is equipped with a position, navigation, and timing (PNT) system that transmits ranging signals to a set of ground-based beacons. These beacons, designed to be unnetworked and stateless, independently respond to the ranging signals without requiring synchronization with other beacons or coordination from a central system. Upon receiving the beacon responses, the airborne PNT system calculates the round-trip ToF for each interaction and determines its own position using multilateration techniques.

Each beacon may self-determine its location upon deployment using GPS, inertial systems, celestial timing, or signals of opportunity. Alternatively, in scenarios where a beacon cannot self-locate, its position may be inferred by airborne systems over time and shared among multiple airborne assets. The beacons include minimal onboard intelligence and are optimized for rapid, large-scale deployment. Because they require no inter-beacon communication, no persistent power, and no infrastructure connectivity, they are highly suitable for use in denied environments. The low-cost, all-COTS design further supports their expendability.

The beacons operate in low-probability-of-intercept (LPI) mode by emitting only microburst responses and remaining silent otherwise. This intermittent transmission scheme not only extends operational life but also makes detection and triangulation by adversaries difficult. In some embodiments, beacons may use RF frequencies that overlap with critical infrastructure or military systems, making jamming undesirable or operationally expensive for an adversary.

To further protect against exploitation, each beacon includes a basic anti-tamper mechanism. If physical tampering or unauthorized access is detected, the beacon may erase or corrupt stored data, disable its transmitter, or enter a permanent silent state. However, due to the distributed nature of the system and the statistical redundancy of beacon deployment, the loss or compromise of individual beacons has no material effect on system functionality.

The PNT system onboard the aircraft is configured to select which beacon responses to use based on signal strength, quality, geometry, or operational relevance (e.g., heading or proximity). This dynamic selection capability ensures robustness even in degraded or partially denied environments.

The disclosed system architecture thus enables fully autonomous, infrastructure-free positioning for UAVs and other airborne assets using round-trip ToF multilateration with expendable, non-networked ground beacons. This shift from centralized computation and fixed infrastructure to distributed, aircraft-centric autonomy represents a critical advancement in resilient navigation for modern operations.

### A. Disposable Beacons

The Global Positioning System (GPS), a satellite-based navigation system, has been the primary source of geolocation information since 1993. It provides simplicity, precision, and global availability, making it a widely adopted system for various applications, including military operations. GPS signals are emitted from satellites orbiting approximately 20,000 kilometers from the Earth's surface. The strength of these signals decreases exponentially as the distance from the satellite to the receiver increases, making the signals relatively weak by the time they reach the Earth's surface.

In the context of military operations, GPS signals are used for positioning and timing on the battlefield. However, these signals are susceptible to interference techniques such as jamming and spoofing. Jamming involves the use of a device that emits radio signals at the same frequency as the GPS signals, thereby overpowering them and preventing the GPS receiver from picking up the legitimate signals. Spoofing, on the other hand, involves the transmission of counterfeit signals that mimic the GPS signals, causing the GPS receiver to calculate an incorrect location.

Terrestrial multilateration (MLAT) is an alternative method of determining the position of an object. It involves the use of multiple ground-based radio stations that emit signals which are received by the object. The time it takes for the signals to travel from the radio stations to the object is measured, and these measurements are used to calculate the object's position. The strength of the signals received by the object is much greater than that of GPS signals due to the closer proximity of the radio stations to the object. However, traditional MLAT systems use fixed, permanent towers, which are not practical for deployment in contested environments.

The present disclosure relates to a navigation system designed to provide precision navigation in environments where Global Positioning System (GPS) signals may be denied or disrupted. The navigation system includes an airborne system equipped with a position, navigation, and timing (PNT) system and a plurality of expendable ground-based beacons. The PNT system is configured to emit radio signals which are received by the ground-based beacons. Upon receiving these signals, the beacons emit corresponding signals back to the PNT system. The PNT system then calculates the round-trip time of flight of these signals and determines the position of the airborne system based on this calculation.

The expendable ground-based beacons are designed to be deployed in a variety of environments, including contested areas, and are configured to self-locate upon deployment. The beacons may utilize various methods for self-location, such as GPS, inertial navigation, signals of opportunity, coherent interferometry, and celestial timing. The beacons are also designed with an anti-tamper system to detect unauthorized access, movement, or tampering, and to erase or corrupt stored data in response to such detection.

Thus, methods and systems of the present disclosure may be improvements to computer technology and/or PNT systems.

### A.1. Environment

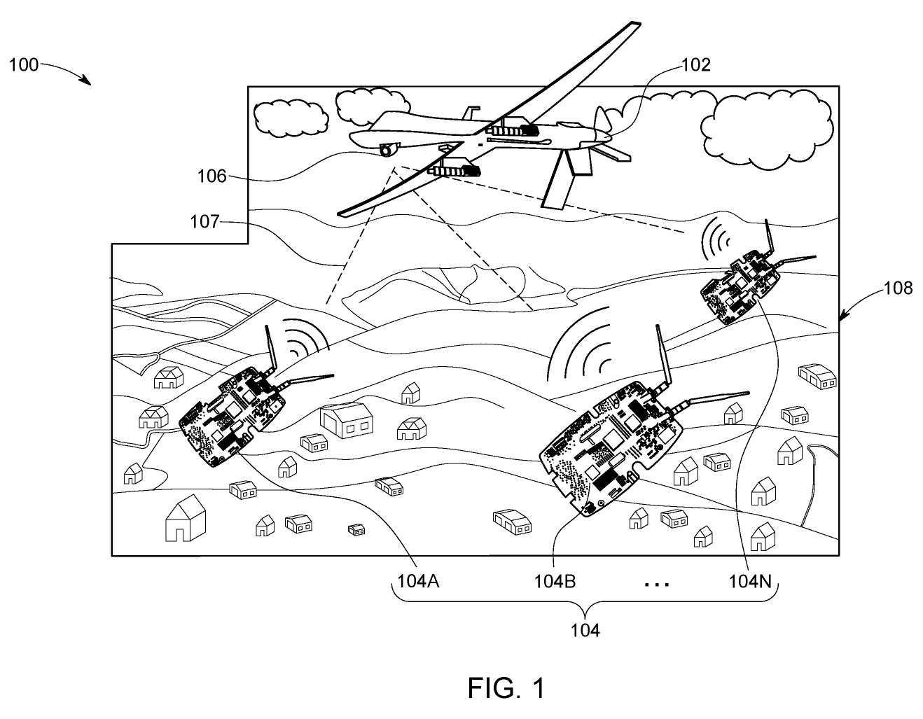

FIG. 1 illustrates an environment 100 for position, navigation, and timing (PNT) using expendable ground-based beacons, according to aspects of the present disclosure.

Referring to FIG. 1, the navigation system includes an airborne system 102 equipped with a position, navigation, and timing (PNT) system 106. In some aspects, the PNT system 106 may be configured to emit first radio signals 107. These first radio signals 107 may be emitted in a variety of patterns or sequences, depending on the specific requirements of the navigation task at hand.

The navigation system also includes a plurality of expendable ground-based beacons 104, which may include a first beacon 104A, a second beacon 104B, up to an Nth beacon 104N. These beacons 104 are configured to receive the first radio signals 107 from the PNT system 106. Upon receiving these first radio signals 107, the beacons 104 may be configured to emit second radio signals 107 back to the PNT system 106. The second radio signals 107 may contain information such as the beacon's identifier, location, and the time of receipt of the first radio signals 107.

The PNT system 106 is further configured to receive the second radio signals 107 from the beacons 104. Upon receiving these second radio signals 107, the PNT system 106 may calculate the round-trip time of flight of the first and second radio signals 107. The round-trip time of flight may be calculated based on the time difference between the emission of the first radio signals 107 and the reception of the second radio signals 107. This calculation may be performed using various methods, such as time-stamping the emission and reception times of the radio signals 107, and then subtracting the emission time from the reception time.

Based on the calculated round-trip time of flight, the PNT system 106 may then determine the position of the airborne system 102. This position determination may be performed using various methods, such as multilateration or triangulation, which utilize the known locations of the beacons 104 and the calculated distances between the airborne system 102 and the beacons 104 to compute the position of the airborne system 102. In some cases, the PNT system 106 may also take into account factors such as signal propagation delays, atmospheric conditions, and beacon clock errors when determining the position of the airborne system 102.

In some aspects, the plurality of expendable ground-based beacons 104, including the first beacon 104A, the second beacon 104B, up to the nth beacon 104N, may be distributed in a geographic area 108. The geographic area 108 may be a specific region of interest, such as a battlefield, a contested airspace, or any other area where navigation is desired. The distribution of the beacons 104 within the geographic area 108 may be random, patterned, or based on specific strategic considerations. For example, the beacons 104 may be distributed to provide coverage over a wide area, to focus on specific points of interest, or to create redundancy in case some beacons 104 are compromised or destroyed.

In some cases, the PNT system 106 onboard the airborne system 102 may emit first radio signals 107. These first radio signals 107 may be emitted in a variety of patterns or sequences, depending on the specific requirements of the navigation task at hand. The first radio signals 107 may be designed to reach the beacons 104 within a specific range, or to target specific beacons 104 based on their known or expected locations.

Upon receiving the first radio signals 107, the beacons 104 may be configured to emit second radio signals 107 back to the PNT system 106. The second radio signals 107 may contain information such as the beacon's identifier, location, and the time of receipt of the first radio signals 107. The second radio signals 107 may be emitted in response to the first radio signals 107, or may be emitted periodically or in response to other triggers.

The PNT system 106 is further configured to receive the second radio signals 107 from the beacons 104. Upon receiving these second radio signals 107, the PNT system 106 may calculate the round-trip time of flight of the first and second radio signals 107. The round-trip time of flight may be calculated based on the time difference between the emission of the first radio signals 107 and the reception of the second radio signals 107. This calculation may be performed using various methods, such as time-stamping the emission and reception times of the radio signals 107, and then subtracting the emission time from the reception time.

Based on the calculated round-trip time of flight, the PNT system 106 may then determine the position of the airborne system 102. This position determination may be performed using various methods, such as multilateration or triangulation, which utilize the known locations of the beacons 104 and the calculated distances between the airborne system 102 and the beacons 104 to compute the position of the airborne system 102. In some cases, the PNT system 106 may also take into account factors such as signal propagation delays, atmospheric conditions, and beacon clock errors when determining the position of the airborne system 102.

### A.2. Components of PNT System and Beacon

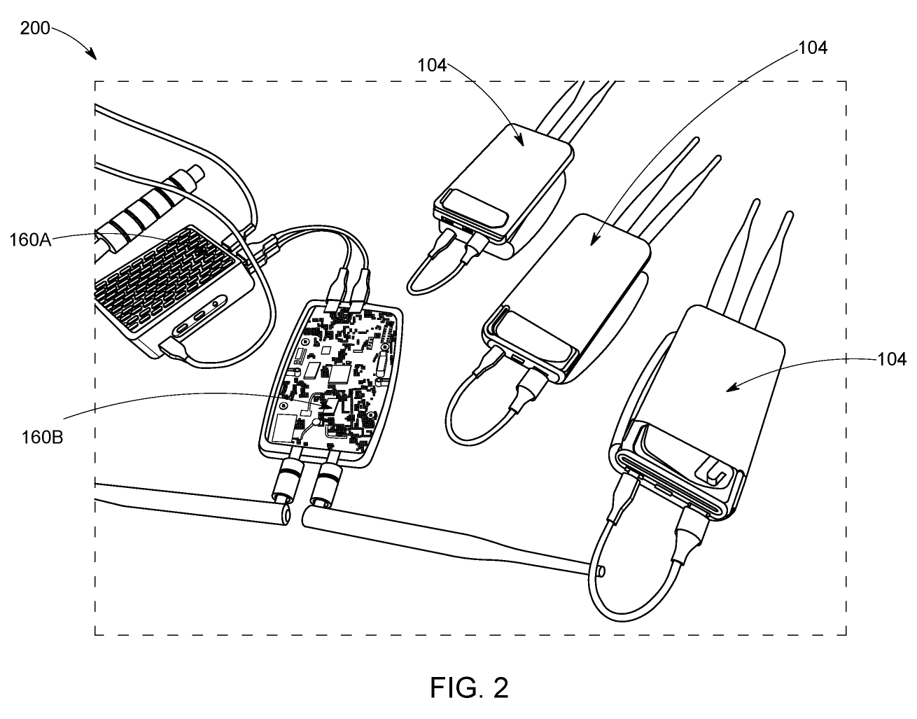

FIG. 2 depicts the components 200 of a PNT system and a beacon, according to aspects of the present disclosure. Features of FIG. 2 may be applied to any of FIGS. 1, 2, 3, 4, 5, 6, or 7.

Referring to FIG. 2, the PNT system 106 includes an edge compute 106A and a radio 106B. The edge compute 106A may be a computing device or system that is capable of performing various computations and processing tasks. In some aspects, the edge compute 106A may include a processor, memory, and other components typically found in computing devices. The edge compute 106A may be configured to perform various tasks related to the operation of the PNT system 106, such as processing signals received from the beacons 104, calculating the round-trip time of flight of the signals, and determining the position of the airborne system 102 based on the calculated round-trip time of flight.

The radio 106B may be a device or system that is capable of transmitting and receiving radio signals. In some aspects, the radio 106B may include a transmitter and a receiver. The transmitter may be configured to emit the first radio signals 107, which are received by the beacons 104. The receiver, on the other hand, may be configured to receive the second radio signals 107 emitted by the beacons 104 in response to the first radio signals 107. The radio 106B may be connected to the edge compute 106A, and may pass the received signals to the edge compute 106A for processing.

In operation, the edge compute 106A may control the radio 106B to emit the first radio signals 107. Upon receiving the second radio signals 107 from the beacons 104, the radio 106B may pass these signals to the edge compute 106A. The edge compute 106A may then calculate the round-trip time of flight of the first and second radio signals 107, and determine the position of the airborne system 102 based on this calculation. In some cases, the edge compute 106A may also take into account factors such as signal propagation delays, atmospheric conditions, and beacon clock errors when determining the position of the airborne system 102.

### A.3. PNT System and Beacons with Interference System

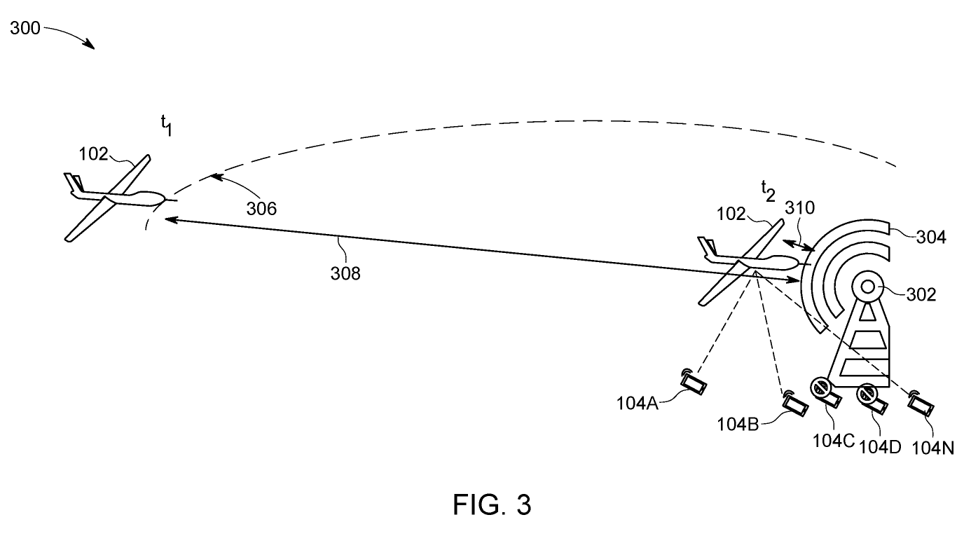

FIG. 3 depicts a diagram 300 of airborne vehicles using the PNT system with expendable beacons for multilateration in the presence of an interference system, according to aspects of the present disclosure. Features of FIG. 3 may be applied to any of FIGS. 1, 2, 4, 5, 6, or 7.

Referring to FIG. 3, the navigation system operates in an environment 100 where GPS signals may be denied or disrupted due to the presence of an interference system 302, such as a jamming or spoofing system, emitting interference signals 304. In such a GPS-denied environment, the airborne system 102 equipped with the PNT system 106 interacts with the expendable ground-based beacons 104 to determine its position.

In some aspects, the PNT system 106 may be configured to perform multilateration by utilizing the second radio signals 107 received from at least three expendable ground-based beacons 104 to determine the position of the airborne system 102. The PNT system 106 may include a multilateration module 414B configured to calculate the position of the airborne system 102 based on the intersection of spheres, each sphere defined by the round-trip time of flight of the first and second radio signals 107 and a corresponding location of a beacon from a respective expendable ground-based beacon 104.

In some cases, the PNT system 106 may be configured to determine the position of the airborne system 102 even in the presence of signal interference by employing multilateration with the second radio signals 107 from the expendable ground-based beacons 104. This capability allows the navigation system to operate effectively in contested environments where GPS signals may be denied or disrupted.

In operation, the PNT system 106 onboard the airborne system 102 may emit first radio signals 107. These first radio signals 107 may be emitted in a variety of patterns or sequences, depending on the specific requirements of the navigation task at hand. The first radio signals 107 may be designed to reach the beacons 104 within a specific range, or to target specific beacons 104 based on their known or expected locations.

Upon receiving the first radio signals 107, the beacons 104 may be configured to emit second radio signals 107 back to the PNT system 106. The second radio signals 107 may contain information such as the beacon's identifier, location, and the time of receipt of the first radio signals 107. The second radio signals 107 may be emitted in response to the first radio signals 107, or may be emitted periodically or in response to other triggers.

The PNT system 106 is further configured to receive the second radio signals 107 from the beacons 104. Upon receiving these second radio signals 107, the PNT system 106 may calculate the round-trip time of flight of the first and second radio signals 107. The round-trip time of flight may be calculated based on the time difference between the emission of the first radio signals 107 and the reception of the second radio signals 107. This calculation may be performed using various methods, such as time-stamping the emission and reception times of the radio signals 107, and then subtracting the emission time from the reception time.

Based on the calculated round-trip time of flight, the PNT system 106 may then determine the position of the airborne system 102. This position determination may be performed using various methods, such as multilateration or triangulation, which utilize the known locations of the beacons 104 and the calculated distances between the airborne system 102 and the beacons 104 to compute the position of the airborne system 102. In some cases, the PNT system 106 may also take into account factors such as signal propagation delays, atmospheric conditions, and beacon clock errors when determining the position of the airborne system 102.

### A.4. PNT System

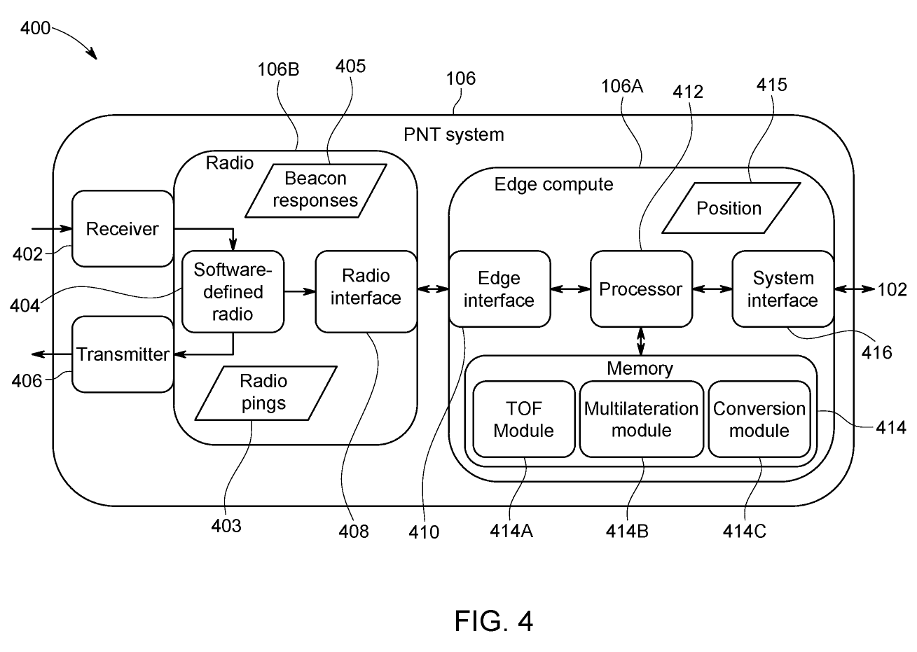

FIG. 4 depicts a block diagram 400 of a PNT system 106, according to aspects of the present disclosure. Features of FIG. 4 may be applied to any of FIGS. 1, 2, 3, 5, 6, or 7.

Referring to FIG. 4, the PNT system 106 includes an edge compute 106A and a radio 106B. The edge compute 106A may be a computing device or system that is capable of performing various computations and processing tasks. In some aspects, the edge compute 106A may include a processor 412, memory 414, and other components typically found in computing devices. The edge compute 106A may be configured to perform various tasks related to the operation of the PNT system 106, such as processing signals received from the beacons 104, calculating the round-trip time of flight of the signals, and determining the position of the airborne system 102 based on this calculation.

The radio 106B may be a device or system that is capable of transmitting and receiving radio signals. In some aspects, the radio 106B may include a receiver 402 and a transmitter 406, which are connected to a software-defined radio 404. The software-defined radio 404 generates and transmits radio pings 403 and receives beacon responses 405. The software-defined radio 404 may pass beacon responses 405 to a radio interface 408, which communicates with an edge interface 410. The edge interface 410 connects to a processor 412 within the edge compute 106A of the PNT system 106. The processor 412 accesses memory 414, which contains a TOF module 414A, a multilateration module 414B, and a conversion module 414C. The processor 412, using the TOF module 414A, the multilateration module 414B, and the conversion module 414C, processes the received beacon signals to determine position data 415. The processor 412 transmits the position data 415 to a system interface 416, which interfaces with an airborne system 102.

In operation, the edge compute 106A may control the radio 106B to emit the first radio signals 107. Upon receiving the second radio signals 107 from the beacons 104, the radio 106B may pass these signals to the edge compute 106A. The edge compute 106A may then calculate the round-trip time of flight of the first and second radio signals 107, and determine the position of the airborne system 102 based on this calculation. In some cases, the edge compute 106A may also take into account factors such as signal propagation delays, atmospheric conditions, and beacon clock errors when determining the position of the airborne system 102.

In some aspects, the PNT system 106 is further configured to determine the time of flight for each of the second radio signals received from the plurality of expendable ground-based beacons 104. The PNT system 106 includes a time of flight (TOF) module 414A configured to calculate the time of flight based on a time difference between emission of the first radio signals and reception of the second radio signals.

In some cases, the PNT system 106 is configured to extract beacon location data and/or beacon identifiers from the second radio signals received from the expendable ground-based beacons 104. The beacon identifiers and the beacon location data extracted from the second radio signals are used by the PNT system 106 to verify the authenticity of the expendable ground-based beacons and/or facilitate selection of the expendable ground-based beacons for position determination.

In some cases, the PNT system 106 may select 3 or more beacons for position determination. In some cases, the PNT system 106 may select beacons based on signal quality (e.g., strength or signal to noise ratio), relative location to PNT system 106, relative location of interference systems, and the like. In some cases, the PNT system 106 may select beacons based on a direction of travel of the PNT system 106. In some cases, the PNT system 106 may select, use, and drop beacons (or signals from beacons) as required to traverse a region.

### A.5. Beacon

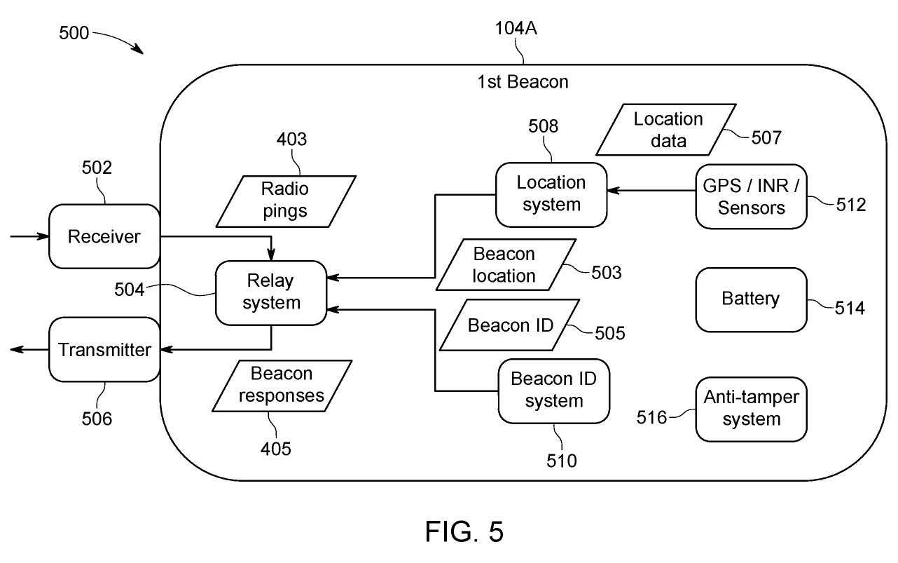

FIG. 5 depicts a block diagram 500 of an expendable ground-based beacon 104A, according to aspects of the present disclosure. Features of FIG. 5 may be applied to any of FIGS. 1, 2, 3, 4, 6, or 7.

Referring to FIG. 5, the first beacon 104A includes several components that enable it to receive, process, and respond to signals from the PNT system 106. These components include a receiver 502, a relay system 504, a transmitter 506, a location system 508, a beacon ID system 510, a battery 514, and an anti-tamper system 516. The battery 514 may power the various components of the first beacon 104A.

The receiver 502 is configured to receive the first radio signals 107 from the PNT system 106. In some aspects, the receiver 502 may be designed to detect and process a specific signal or range of signals from the PNT system 106. Upon receiving the first radio signals 107, the receiver 502 may pass these signals to the relay system 504 for further processing.

The relay system 504 is configured to process the first radio signals 107 received from the receiver 502 and generate corresponding second radio signals 107. The relay system 504 may include various components and subsystems to perform this processing, such as signal processing circuits, timing circuits, and control circuits. In some cases, the relay system 504 may also include encryption or decryption capabilities to ensure the security and integrity of the signals.

In some aspects, the relay system 504 is further configured to include beacon location data in the second radio signals 107. The beacon location data may be determined by the location system 508, which may utilize various methods for self-location, such as GPS, inertial navigation, signals of opportunity, coherent interferometry, and celestial timing. The location system 508 may obtain location data 507 for one or more of the foregoing from GPS, INR, or sensor systems 512. The inclusion of the beacon location data in the second radio signals 107 allows the PNT system 106 to determine the position of the airborne system 102 based on the known locations of the beacons 104 and the calculated round-trip time of flight of the first and second radio signals 107.

In some cases, the relay system 504 is further configured to include a beacon identifier in the second radio signals 107. The beacon identifier may be a code or other form of identification that uniquely identifies the first beacon 104A. The inclusion of the beacon identifier in the second radio signals 107 allows the PNT system 106 to identify and authenticate the first beacon 104A based on the received second radio signals 107. This feature may enhance the security and reliability of the navigation system by preventing unauthorized or counterfeit beacons from interfering with the operation of the system.

The relay system 504 may include at least one field programmable gate array (FPGA) to provide consistent generation and transmission of the second radio signals 107. The FPGA may be a programmable integrated circuit that can be configured to perform specific tasks, such as signal processing, timing control, and data encryption. The use of an FPGA in the relay system 504 allows for precise control over the timing and characteristics of the second radio signals 107, thereby ensuring consistent and accurate signal transmission.

In some aspects, the relay system 504 may include a plurality of FPGAs. The use of multiple FPGAs may provide additional processing power and flexibility, allowing the relay system 504 to handle more complex tasks or to process signals more quickly. The plurality of FPGAs may be interconnected in various ways, such as in a parallel configuration, a serial configuration, or a combination thereof.

In some cases, the plurality of FPGAs in the relay system 504 may be daisy chained. Daisy chaining is a method of connecting multiple devices in sequence, where each device is connected to the next device in the chain. This configuration allows for efficient data transfer between the FPGAs, and may also provide redundancy in case one of the FPGAs fails or is compromised. The use of a daisy chain configuration in the relay system 504 may enhance the reliability and robustness of the navigation system.

The transmitter 506 is configured to emit the second radio signals 107 generated by the relay system 504. These second radio signals 107 are emitted in response to the first radio signals 107 received from the PNT system 106. The transmitter 506 may be designed to emit the second radio signals 107 at a specific frequency or range of frequencies, and may include various components and subsystems to control the timing, power, and direction of the emitted signals. For instance, the frequency or range of frequencies may include frequencies such as those used by cellular networks, military communications, critical infrastructure, or other frequencies that are strategically problematic for an adversary to jam, as such action would com-promise their own equipment or methods of communication. In some cases, optical transmission may be used instead of radio frequencies, or in combination with radio frequencies.

In some cases, the system operates on extremely short burst signals, separated by long periods of silence. Signal transmission from the PNT system and the beacons may last only a short period of time (e.g., a few microseconds) and be separated by longer periods of time (e.g., twenty to thirty minutes) of silence. This may make locating the beacons by triangulation techniques (e.g., correlative interferometry) extremely difficult. In addition, this technique enables implementation of sub noise floor communication protocols and other off the shelf LPI/LPD transmission methods. All of this may combine to make individual beacons very difficult to locate.

In some cases, due to the beacons small size and/or form factor, the beacons can be disguised as foliage or trash to maximize survivability when seeding geographic area of operation. At the same time, due to a low-cost, high-volume approach (e.g., made possible by the all-COTS design), beacon survivability is of little concern. In the event a large portion of the beacons are captured or destroyed, the system still functions as intended.

The location system 508 is configured to determine the location of the first beacon 104A upon deployment. The location system 508 may utilize various methods for self-location, such as GPS, inertial navigation, signals of opportunity, coherent interferometry, and celestial timing. The location data determined by the location system 508 may be included in the second radio signals 107 emitted by the transmitter 506.

The beacon ID system 510 manages a beacon ID 505 that uniquely identifies the first beacon 104A. The beacon ID 505 may be included in the second radio signals 107 emitted by the transmitter 506. This allows the PNT system 106 to identify and authenticate the first beacon 104A based on the received second radio signals 107.

The anti-tamper system 516 is configured to detect unauthorized access, movement, or tampering with the first beacon 104A. Upon detecting such tampering, the anti-tamper system 516 may take various actions to protect the integrity and security of the first beacon 104A. For example, the anti-tamper system 516 may erase or corrupt stored data within the first beacon 104A, disable the beacon's radio signal emission capability, or trigger a self-destruction mechanism. This ensures that the first beacon 104A remains secure and reliable even in contested environments. In the case of erasing or corrupting stored data within the first beacon 104A, this may ensure that any sensitive information stored within the first beacon 104A is not accessible to unauthorized individuals or entities. In the case of disabling the beacon's radio signal emission capability upon detection of tampering, this may prevent the beacon from being used to transmit false or misleading signals that could disrupt the operation of the navigation system.

In some cases, the beacon locations are determined from outside the beacon and the beacon does not transmit beacon location. For instance, an airborne vehicle 102 may know its location (e.g., because of GPS) and track a relative location of a beacon based on different received second signals from the beacon. Using this information over time, the PNT system 106 (or other system, e.g., a server) may determine a location of the beacon and this information may be shared among PNT systems 106 on airborne aircraft 102 near the beacon.

### A.6. Dataflow Diagram

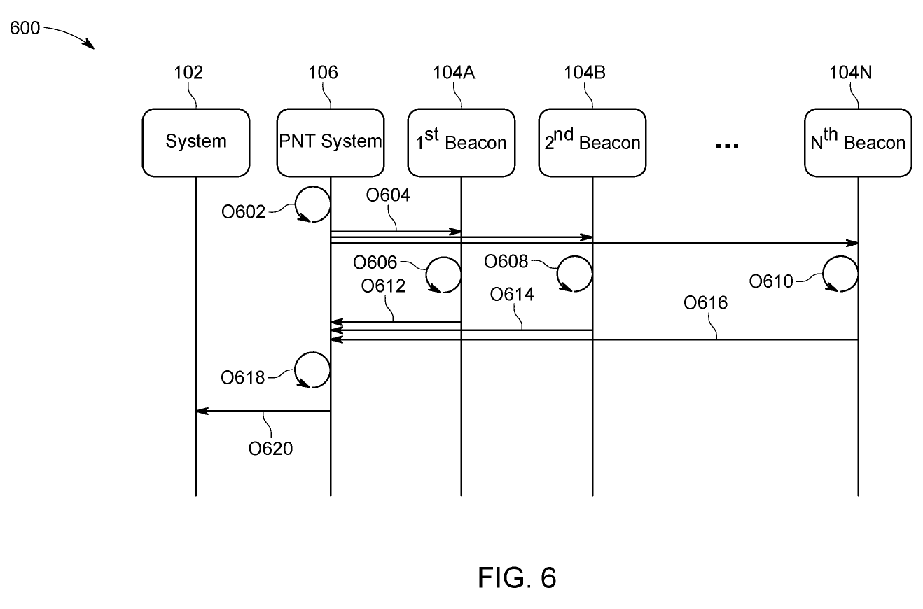

FIG. 6 depicts a dataflow diagram of a navigation system using expendable ground-based beacons and a PNT system, according to aspects of the present disclosure. Features of FIG. 6 may be applied to any of FIGS. 1, 2, 3, 4, 5, or 7.

Referring to FIG. 6, a dataflow diagram 600 illustrates the operations of the PNT system 106 and the expendable ground-based beacons 104 in transmitting, receiving, and processing signals to determine the position of the airborne system 102.

In some aspects, the PNT system 106 may determine a trigger condition for a ping at operation O602. The trigger condition may be based on various factors, such as timers, the current position of the airborne system 102, the known or expected locations of the beacons 104, or other operational parameters (such as detecting interference signals or degraded GPS signal). Upon determining the trigger condition, the PNT system 106 may transmit pings, which are a type of first radio signals 107, at operation O604. These pings may be transmitted to multiple beacons 104 within a specific range or to target specific beacons 104 based on their known or expected locations.

Upon receiving the pings, each beacon 104 may process the ping and generate a corresponding response. For example, the first beacon 104A may process the ping at operation O612 and generate a first response. The first beacon 104A may then transmit the first response to the PNT system 106 at operation O614. Similarly, the second beacon 104B may process the ping at operation O608 and generate a second response, which is transmitted to the PNT system 106 at operation O610. This process continues for each beacon 104 within range of the PNT system 106 and not blocked by interference signals from interference systems.

The PNT system 106 is further configured to receive the responses from the beacons 104. Upon receiving these responses, the PNT system 106 may calculate the round-trip time of flight for each response at operation O618. The round-trip time of flight may be calculated based on the time difference between the emission of the pings and the reception of the responses. This calculation may be performed using various methods, such as time-stamping the emission and reception times of the pings and responses, and then subtracting the emission time from the reception time.

Based on the calculated round-trip time of flight, the PNT system 106 may then determine the position of the airborne system 102 at operation O620. This position determination may be performed using various methods, such as multilateration or triangulation, which utilize the known locations of the beacons 104 and the calculated round-trip time of flight of the pings and responses to compute the position of the airborne system 102. In some cases, the PNT system 106 may also take into account factors such as signal propagation delays, atmospheric conditions, and beacon clock errors when determining the position of the airborne system 102.

### A.7. Flowchart

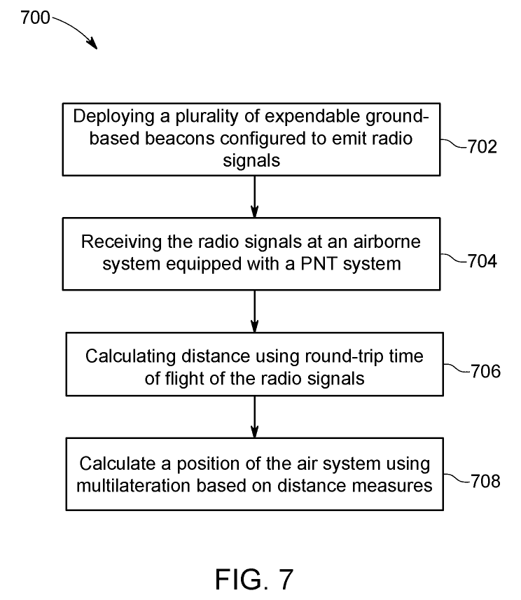

FIG. 7 depicts a flowchart of a navigation method, according to aspects of the present disclosure. Features of FIG. 7 may be applied to any of FIGS. 1, 2, 3, 4, 5, or 6.

Referring to FIG. 7, a flowchart 700 illustrates a sequence of operations performed by the airborne system 102 and the PNT system 106 in emitting, receiving, and processing radio signals to calculate the round-trip time of flight and determine the position of the airborne system 102.

At block 702, the PNT system 106 onboard the airborne system 102 may emit first radio signals 107. These first radio signals 107 may be emitted in a variety of patterns or sequences, depending on the specific requirements of the navigation task at hand. The first radio signals 107 may be designed to reach the beacons 104 within a specific range, or to target specific beacons 104 based on their known or expected locations.

Upon receiving the first radio signals 107, the beacons 104 may be configured to emit second radio signals 107 back to the PNT system 106, as depicted at block 704. The second radio signals 107 may contain information such as the beacon's identifier, location, and the time of receipt of the first radio signals 107. The second radio signals 107 may be emitted in response to the first radio signals 107, or may be emitted periodically or in response to other triggers.

At block 706, the PNT system 106 is further configured to receive the second radio signals 107 from the beacons 104. Upon receiving these second radio signals 107, the PNT system 106 may calculate the round-trip time of flight of the first and second radio signals 107 and calculate a distance using round-trip time of flight of the radio signals. The round-trip time of flight may be calculated based on the time difference between the emission of the first radio signals 107 and the reception of the second radio signals 107. This calculation may be performed using various methods, such as time-stamping the emission and reception times of the radio signals 107, and then subtracting the emission time from the reception time.

Based on the calculated round-trip time of flight and/or the calculated distance, the PNT system 106 may then determine the position of the airborne system 102 at block 708. This position determination may be performed using various methods, such as multilateration or triangulation, which utilize the known locations of the beacons 104 and the calculated distances between the airborne system 102 and the beacons 104 to compute the position of the airborne system 102. In some cases, the PNT system 106 may also take into account factors such as signal propagation delays, atmospheric conditions, and beacon clock errors when determining the position of the airborne system 102.

### B. ADS-B+P with Reflectors

Positioning systems play a crucial role in modern aviation, providing accurate location information for aircraft navigation and safety. Automatic Dependent Surveillance-Broadcast (ADS-B) technology has emerged as a key component of air traffic management systems, enabling aircraft to broadcast their position, velocity, and other information to ground stations and other aircraft.

While Global Positioning System (GPS) technology has been widely adopted for aircraft positioning, there are scenarios where GPS signals may be unavailable or compromised. These situations can occur due to natural obstructions, signal interference, or intentional jamming. As a result, there is ongoing interest in developing alternative or complementary positioning methods that can enhance the reliability and accuracy of aircraft navigation systems.

Ground-based positioning systems have been explored as potential solutions to augment or supplement satellite-based navigation. These systems typically involve a network of ground stations that interact with airborne equipment to determine an aircraft's position. However, implementing such systems often requires extensive infrastructure and may face challenges related to coverage, accuracy, and integration with existing avionics.

The aviation industry continues to seek improvements in positioning technologies that can provide robust performance across various operational environments. Enhancing the capabilities of existing systems, such as ADS-B, to support more accurate and reliable positioning could offer benefits in terms of safety, efficiency, and operational flexibility.

As air traffic continues to grow and new types of aircraft, including unmanned aerial vehicles, enter the airspace, the demand for precise and dependable positioning systems is likely to increase. Developing solutions that can leverage existing infrastructure while offering improved performance and resilience to signal disruptions remains an area of active research and development in the field of aviation technology.

The present disclosure relates to a navigation system designed to provide precision positioning in various environments. The navigation system utilizes Automatic Dependent Surveillance-Broadcast (ADS-B) signals in conjunction with ground-based reflectors to determine the position of an aircraft or other airborne vehicle. This approach may offer advantages in terms of accuracy, reliability, and resilience to signal interference.

The system includes an airborne component equipped with ADS-B capabilities and a network of ground-based reflectors. The airborne component transmits ADS-B signals, which are received and reflected by the ground-based reflectors. By analyzing the timing and characteristics of these reflected signals, the system can calculate the position of the airborne vehicle.

In some cases, this positioning method may be integrated with existing Global Positioning System (GPS) capabilities, providing a complementary or alternative means of navigation. The combination of ADS-B technology and ground reflectors may enable precise positioning even in scenarios where GPS signals are unavailable or compromised.

The navigation system described herein may have applications in various fields, including aviation, unmanned aerial vehicles, and potentially in other transportation sectors. By leveraging existing ADS-B infrastructure and adding ground-based reflectors, the system may offer a cost-effective and readily implementable solution for enhanced positioning capabilities.

### B.1. ADS-B+P Systems

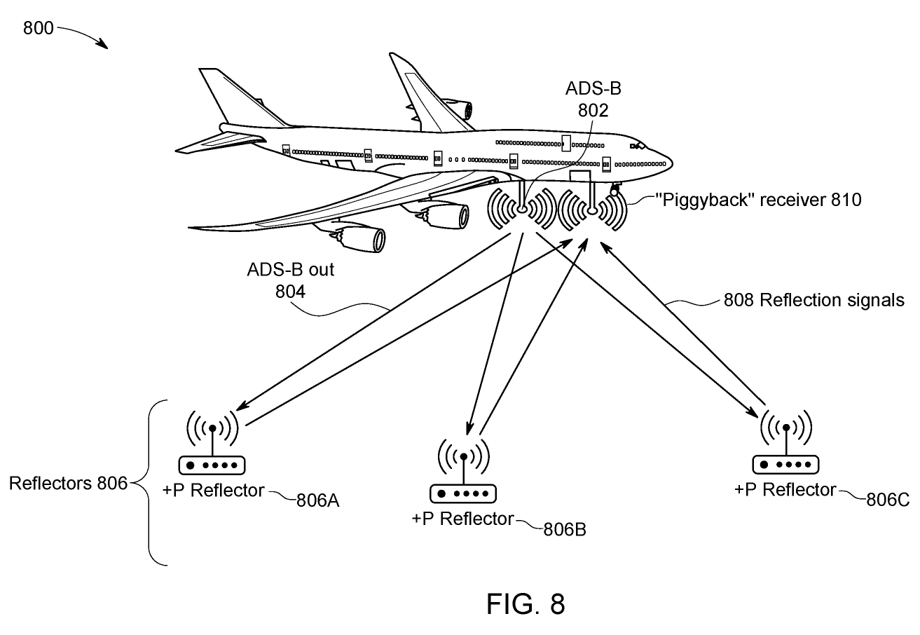

FIG. 8 illustrates a positioning system 800 that utilizes ADS-B signals and ground reflectors. The system includes an aircraft equipped with an ADS-B 802 that transmits an ADS-B signal 804 to a ground reflector array 806. The ground reflector array 806 comprises multiple reflectors including a first ground reflector 806A, a second ground reflector 806B, and a third ground reflector 806C positioned at different locations on the ground.

In some aspects, the ground reflectors in the positioning system may share similarities with the beacons described earlier, but may possess distinct characteristics tailored to their specific role in the ADS-B+P system. In some cases, these reflectors may be designed as fixed installations rather than mobile units, offering enhanced stability and longevity in their operation.

The ground reflectors may be permanently installed at predetermined locations, which may allow for precise calibration and consistent performance over time. This fixed nature may contrast with the potentially disposable and movable nature of some beacon designs. The stable positioning of these reflectors may contribute to the overall accuracy and reliability of the multilateration calculations performed by the system.

In some implementations, the ground reflectors may be connected to the power grid, eliminating the need for battery power. This connection to a stable power source may allow for continuous operation without the need for periodic battery replacements or recharging. The wired power supply may also enable the use of more powerful signal processing and transmission capabilities, enhancing the range and effectiveness of the reflection signals.

The fixed installation and wired power supply of these reflectors may allow for more robust and weather-resistant designs compared to battery-powered, movable beacons. This durability may contribute to lower maintenance requirements and longer operational lifespans for the reflector units.

While sharing the core functionality of signal reflection with the previously described beacons, these fixed and wired reflectors may offer advantages in terms of reliability, accuracy, and long-term operational efficiency within the ADS-B+P positioning system.

The aircraft transmits the ADS-B signal 804 which is received by the ground reflectors. The ground reflectors then generate reflection signals 808 that are transmitted back to the aircraft. A piggyback receiver 810 mounted on the aircraft receives these reflection signals 808 from the ground reflector array 806.

In some aspects, the piggyback receiver 810 may be similar to or functionally equivalent to the PNT system 106 described earlier, but with modifications to accommodate the ADS-B+P system architecture. The piggyback receiver 810 may be configured to determine the time of flight from the outgoing ADS-B signal in addition to processing the incoming reflection signals 808. This capability may be implemented in various ways. For instance, the piggyback receiver 810 may directly detect the ADS-B signal as it is transmitted from the aircraft, allowing it to establish a precise timestamp for the signal's emission. Alternatively, the piggyback receiver 810 may receive an out-of-band notice or time stamp from the ADS-B system, providing the necessary timing information without directly detecting the outgoing signal. This integration with the ADS-B system may allow the piggyback receiver 810 to accurately calculate the round-trip time of flight for the signals, enabling precise position determination using the ground reflector array 806.

The detection of the ADS-B signal at a known distance away may enable determination of the time of transmission of the ADS-B signal through a process of time synchronization and signal propagation analysis.

In some aspects, the piggyback receiver 810 may be placed at a precisely known distance from the aircraft's ADS-B transmitter. When the ADS-B signal is detected by the piggyback receiver 810, the time of detection can be recorded with high precision. Given that the speed of radio wave propagation is known (approximately the speed of light), the time taken for the signal to travel the known distance can be calculated.

By subtracting this calculated travel time from the time of signal detection at the piggyback receiver 810, the system may determine the original transmission time of the ADS-B signal. This process may effectively establish a precise timestamp for the ADS-B signal emission without requiring direct access to the aircraft's internal clock.

In some implementations, multiple receivers at different known distances may be used to further refine the accuracy of the transmission time determination. The system may compare the detection times across these receivers, allowing for compensation of atmospheric effects or other sources of timing discrepancies.

This method of time synchronization may provide a reliable means of establishing the ADS-B signal transmission time, which may be crucial for accurate calculation of round-trip time of flight in the positioning system. The known piggyback receiver 810 distance may serve as a calibration point, enabling the system to precisely measure signal propagation times and, consequently, determine aircraft position through multilateration techniques.

The positioning system 800 operates by transmitting the ADS-B signal 804 from the aircraft to the ground reflector array 806. Each reflector (806A, 806B, 806C) receives this signal and sends back reflection signals 808 to the piggyback receiver 810 on the aircraft. The system uses the timing of these signals to determine the aircraft's position through multilateration.

In some cases, the ground reflector array 806 may use DME frequencies of 960 MHz - 1215 MHz for the reflection signals 808. This frequency range may provide suitable propagation characteristics for the positioning system 800.

In some cases, the ground reflector array 806 may use VOR frequencies of 108.0 MHz - 117.95 MHz for the reflection signals 808. These frequencies may be utilized as VOR systems are decommissioned, repurposing the spectrum for the positioning system 800.

In some cases, the positioning system 800 may use the UAT 978 MHz frequency for the reflection signals 808. This frequency may be compatible with existing ADS-B infrastructure and provide an additional option for signal transmission.

The use of these various frequency options may allow the positioning system 800 to operate effectively in different environments and regulatory contexts, providing flexibility in implementation and operation.

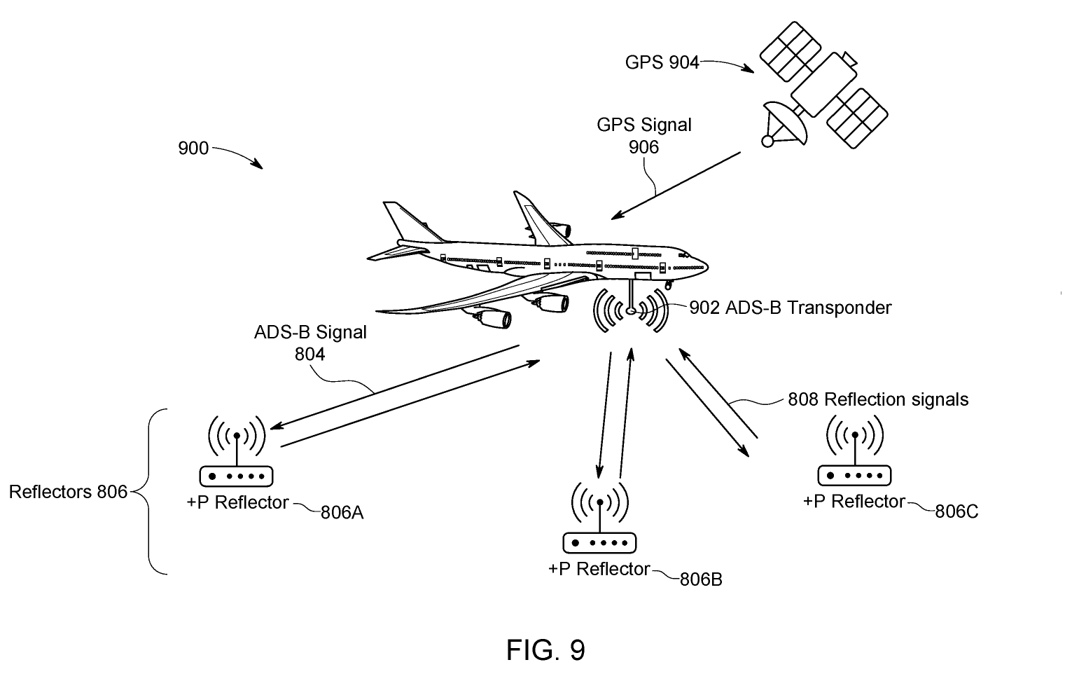

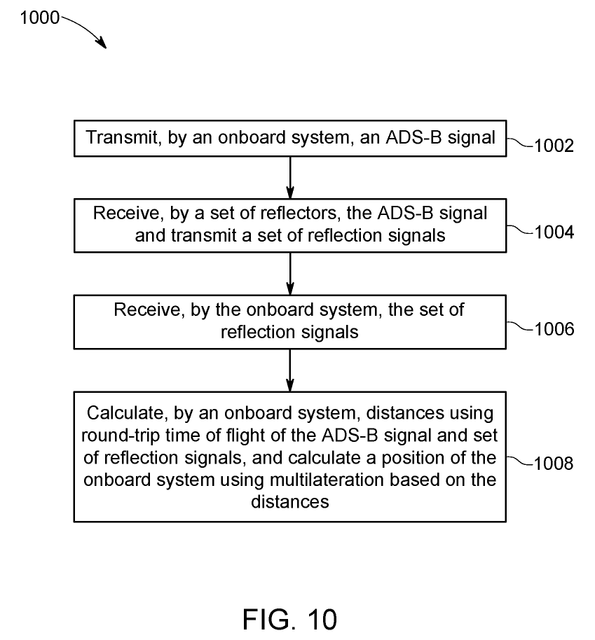

FIG. 9 illustrates a positioning system 900 that utilizes both satellite and ground-based positioning capabilities. The positioning system 900 includes an aircraft equipped with an aircraft transponder 902 that receives signals from multiple sources. A GPS satellite 904 transmits GPS signals 906 to the aircraft GPS system (e.g., in the aircraft transponder 902 or a separate system).

The positioning system 900 also includes a ground reflector array 806 comprising multiple ground reflectors: a first ground reflector 806A, a second ground reflector 806B, and a third ground reflector 806C. The aircraft transponder 902 transmits ADS-B signals 804 which are received by the ground reflectors. The ground reflectors then transmit reflection signals 808 back to the aircraft transponder 902.

In some cases, the positioning system 900 may be fully integrated into the aircraft transponder 902. This integration may allow for seamless operation and data processing within a single unit, reducing complexity and improving reliability.

The positioning system 900 operates by utilizing both the GPS signals 906 from the GPS satellite 904 and the reflection signals 808 from the ground reflector array 806. The aircraft transponder 902 processes these signals to determine the aircraft's position. The ground reflectors 806A, 806B, and 806C may be arranged in a configuration that enables multilateration positioning based on the timing of the reflection signals 808 in response to the transmitted ADS-B signals 804.

In some cases, the positioning system 900 may provide GPS level accuracy in all phases of flight. This high level of accuracy may be achieved through the combination of satellite-based GPS positioning and ground-based multilateration using the ADS-B signals 804 and reflection signals 808. The integration of these two positioning methods may allow for enhanced accuracy and reliability, particularly in situations where GPS signals may be weak or unavailable.

The aircraft transponder 902 may use sophisticated algorithms to process and combine the data from both the GPS signals 906 and the reflection signals 808. This data fusion may result in a more robust and accurate position determination compared to using either method alone. The use of multiple ground reflectors (806A, 806B, 806C) in the ground reflector array 806 may further enhance the accuracy of the position calculation through redundancy and improved geometric diversity.

### B.2. ADS-B+P Flowchart

The present disclosure relates to a navigation system designed to provide precision positioning in various environments. The navigation system utilizes automatic dependent surveillance-broadcast (ADS-B) signals in conjunction with ground-based reflectors to determine the position of an aircraft or other airborne vehicle. This approach may offer advantages in terms of accuracy, reliability, and resilience to signal interference.

The system includes an airborne component equipped with ADS-B capabilities and a network of ground-based reflectors. The airborne component transmits ADS-B signals, which are received and reflected by the ground-based reflectors. By analyzing the timing and characteristics of these reflected signals, the system can calculate the position of the airborne vehicle.

In some cases, this positioning method may be integrated with existing Global Positioning System (GPS) capabilities, providing a complementary or alternative means of navigation. The combination of ADS-B technology and ground reflectors may enable precise positioning even in scenarios where GPS signals are unavailable or compromised.

The navigation system described herein may have applications in various fields, including aviation, unmanned aerial vehicles, and in other transportation sectors. By leveraging existing ADS-B infrastructure (or an equivalent) and adding ground-based reflectors, the system may offer a cost-effective and readily implementable solution for enhanced positioning capabilities.

The positioning system comprises an onboard (e.g., airborne) system equipped with an Automatic Dependent Surveillance-Broadcast (ADS-B) transmitter. This airborne system may be integrated into an aircraft's existing avionics infrastructure, providing seamless operation alongside other navigation and communication systems.

In some cases, the ADS-B transmitter may be configured to emit ADS-B signals at regular intervals. These ADS-B signals may contain information such as the aircraft's identification, position, altitude, and velocity. The emission of these signals may serve multiple purposes, including air traffic control and the positioning function described in this disclosure.

The airborne system may be designed to function in parallel with Global Positioning System (GPS) capabilities. This parallel operation may allow for redundancy in positioning data, enhancing the overall accuracy and reliability of the aircraft's navigation system. In some cases, the integration with current avionics may enable the system to utilize both ADS-B and GPS signals for position determination.

In some implementations, the positioning system may be fully integrated into an aircraft transponder. This integration may allow for efficient processing of both ADS-B and GPS signals within a single unit. The aircraft transponder may be configured to emit the ADS-B signals and simultaneously process the received GPS signals and reflection signals, reducing the need for additional hardware components.

The ADS-B transmitter in the airborne system may be designed to operate on specific frequencies. In some cases, the transmitter may use the 1090 MHz frequency for ADS-B signal transmission. Alternatively, the system may utilize the Universal Access Transceiver (UAT) frequency of 978 MHz The choice of frequency may depend on factors such as regulatory requirements, aircraft type, and operational environment.

In some implementations, the airborne system may include additional components to enhance its functionality. For example, the system may incorporate a high-precision clock to ensure accurate timing of the ADS-B signal transmissions and reception of the reflection signals. This precise timing may be crucial for the subsequent position calculations based on signal reflections from ground-based reflectors.

The airborne system may also include data processing capabilities to manage the transmission of ADS-B signals and interpretate the received reflection signals. In some cases, this processing may involve algorithms for signal generation, error correction, and data formatting to ensure compliance with ADS-B standards and protocols.

The integration of the positioning system with existing avionics may allow for the sharing of data between different aircraft systems. For instance, altitude data from the aircraft's altimeter may be incorporated into the ADS-B signals, providing additional information for position determination. Similarly, data from inertial navigation systems or air data computers may be utilized to enhance the accuracy of the transmitted position information.

The airborne system may also include features for signal integrity monitoring and fault detection. These features may help ensure the reliability of the transmitted ADS-B signals and quickly identify any malfunctions or anomalies in the system's operation.

In some cases, the airborne system may be designed with modular components, allowing for easy upgrades or replacements as technology advances or regulatory requirements change. This modularity may extend the operational lifespan of the system and facilitate the integration of new capabilities over time.

The positioning system's seamless integration with current avionics may allow pilots and air traffic controllers to utilize familiar interfaces and procedures while benefiting from the enhanced positioning capabilities. This integration may minimize the need for extensive training or significant changes to existing operational protocols.

In summary, the airborne system equipped with an ADS-B transmitter serves as a core component of the positioning system, emitting signals that enable precise position determination through interaction with ground-based reflectors. Its integration with existing avionics and parallel operation with GPS capabilities may provide a robust and reliable solution for aircraft positioning across various operational scenarios.

The positioning system comprises a plurality of ground-based reflectors designed to receive Automatic Dependent Surveillance-Broadcast (ADS-B) signals and emit reflection signals. These ground-based reflectors may be deployed in a distributed manner across a geographic area, providing coverage for airborne systems equipped with ADS-B capabilities.

In some cases, the ground-based reflectors may be configured to emit reflection signals on a frequency different from the ADS-B signals. This frequency separation may allow for clearer signal differentiation and processing. The frequency of the reflection signals may be within a range of 960 MHz to 1215 MHz, which corresponds to the Distance Measuring Equipment (DME) frequency band.

In some implementations, the positioning system may utilize the Universal Access Transceiver (UAT) 978 MHz frequency for the reflection signals. This frequency choice may leverage existing infrastructure and equipment compatibility.

As Very High Frequency Omnidirectional Range (VOR) systems are decommissioned, the positioning system may repurpose VOR frequencies (108.0 MHz - 117.95 MHz) for the reflection signals. This approach may efficiently utilize available spectrum resources.

The ground-based reflectors may be designed to operate without a central server or interconnected network. This decentralized architecture may enhance system resilience and reduce infrastructure requirements. Each reflector may function independently, receiving ADS-B signals and emitting reflection signals without relying on communication with other reflectors or a central control system.

In some cases, the ground-based reflectors may add location and/or time stamp information to the reflection signals. This feature may eliminate the need for a database of reflector locations on the airborne system. By transmitting their own location data with the reflection signals, the reflectors may enable dynamic and accurate positioning calculations without relying on pre-stored location information.

In some cases, the ground-based reflectors may be designed to be expendable and low-cost. This approach may enable easy scaling of the system and facilitate deployment in various environments, including challenging or contested areas. The low-cost nature of the reflectors may allow for widespread distribution and frequent replacement or updates as needed.

In some implementations, the reflectors may be designed with minimal power requirements, potentially utilizing solar power or long-life batteries. This design choice may extend the operational lifespan of the reflectors and reduce maintenance needs.

The reflectors may be constructed using weather-resistant materials to withstand various environmental conditions. In some cases, the reflectors may be designed with a low visual profile to minimize their visibility and potential for tampering.

Deployment strategies for the ground-based reflectors may vary depending on the specific application and environment. In urban areas, reflectors may be mounted on existing structures such as buildings or utility poles. In rural or remote areas, reflectors may be deployed as standalone units, potentially camouflaged to blend with the surrounding environment.

In some cases, the reflectors may be designed with multiple antennas to provide omnidirectional coverage. This configuration may ensure that reflection signals can be emitted and received regardless of the relative position of the airborne system.

The ground-based reflectors may incorporate signal processing capabilities to filter and amplify received ADS-B signals before generating the reflection signals. This processing may help maintain signal integrity and improve the overall performance of the positioning system.

In some implementations, the reflectors may be equipped with self-diagnostic capabilities. These features may allow the reflectors to monitor their own performance and report any issues or malfunctions, facilitating maintenance and ensuring system reliability.

The positioning system may employ various techniques to optimize the distribution and density of ground-based reflectors. In areas with high air traffic, a higher density of reflectors may be deployed to provide more accurate positioning. In less frequented areas, a sparser distribution may be sufficient.

In some cases, the reflectors may be designed with adjustable transmission power. This feature may allow for dynamic adaptation to different operational environments and regulatory requirements, optimizing signal coverage while minimizing potential interference.

The ground-based reflectors may be configured to operate in different modes depending on the specific needs of the positioning system. For example, some reflectors may be set to emit reflection signals continuously, while others may operate on a triggered basis, emitting signals only when ADS-B signals are detected.

In some implementations, the reflectors may incorporate encryption or other security measures to prevent unauthorized access or signal spoofing. These security features may enhance the overall integrity and reliability of the positioning system.

The design and deployment of the ground-based reflectors may be tailored to complement existing navigation infrastructure, providing enhanced coverage in areas where traditional navigation aids may be limited or unavailable. This approach may result in a more robust and comprehensive positioning solution for airborne systems.

The positioning system comprises a receiver on the airborne system. This receiver may be configured to receive reflection signals from ground-based reflectors. In some cases, the receiver may be designed to detect and process specific frequencies used for the reflection signals, such as DME frequencies or VOR frequencies.

The receiver may interface with other components of the airborne system, such as the ADS-B transmitter and position calculation systems. In some cases, the receiver may pass the received reflection signals to a processing unit for further analysis and position determination.

In some implementations, the receiver may be a piggyback receiver mounted separately from the ADS-B transmitter. This configuration may allow for easier integration with existing aircraft systems without requiring modifications to the ADS-B transmitter itself. The piggyback receiver may be installed in a location on the aircraft that optimizes signal reception from the ground-based reflectors.

Various receiver configurations may be employed depending on the specific requirements of the positioning system. For example, the receiver may utilize software-defined radio technology, allowing for flexibility in signal processing and frequency selection. In some cases, the receiver may incorporate multiple antennas to improve signal reception and mitigate multipath effects.

The receiver may also include filtering and amplification stages to enhance the quality of the received reflection signals. In some implementations, the receiver may employ advanced signal processing techniques, such as correlation or matched filtering, to extract timing information from the received signals accurately.

In some cases, the receiver may be designed with redundancy features to ensure reliable operation. This may include dual receiver channels or backup power supplies to maintain functionality in case of component failure.

The receiver may also be equipped with built-in test capabilities to monitor its performance and detect any malfunctions. In some implementations, the receiver may provide status information to the aircraft's avionics systems, allowing for integration with existing PNT systems, health monitoring systems, and diagnostic tools.

The positioning system may calculate the position of the airborne system based on round-trip time of flight between emission of ADS-B signals and reception of reflection signals. FIG. 10 illustrates a flowchart of a method 1000 for determining position using ADS-B signals and ground-based reflectors.

A method 1000 may begin with a step 1002, where an onboard system transmits an ADS-B signal. In a step 1004, a set of reflectors may receive the ADS-B signal and transmit a set of reflection signals. The method 1000 may continue with a step 1006, where the onboard system receives the set of reflection signals. In a step 1008, the onboard system may calculate distances using round-trip time of flight of the ADS-B signal and set of reflection signals, and calculate a position of the onboard system using multilateration based on the distances.

The positioning system may determine the position of the airborne system using multilateration based on calculated distances. Multilateration may involve measuring the time difference of arrival (TDOA) of signals from multiple reflectors to determine the position of the airborne system. The positioning system may calculate the distances between the airborne system and each ground-based reflector based on the round-trip time of flight.

The positioning system may determine the position of the airborne system using a combination of reflection signals and GPS signals when available. This hybrid approach may enhance accuracy and reliability, especially in scenarios where GPS signals may be weak or intermittent.

In some cases, the positioning system may support precision landing requirements for future automated aircraft, including unmanned aircraft and air taxis. The high accuracy provided by multilateration may enable safe and precise landings in various conditions.

The positioning system may select a subset of ground-based reflectors based on signal quality. This selection process may involve evaluating factors such as signal strength, signal-to-noise ratio, or geometric dilution of precision (GDOP). By choosing the reflectors with the strongest and clearest signals, the positioning system may improve the accuracy of the position calculation.

In some cases, the positioning system may dynamically adjust position calculation based on the number of operational ground-based reflectors. As reflectors become available or unavailable, the positioning system may adapt its calculations to maintain optimal accuracy. This dynamic adjustment may ensure consistent performance even in changing environments or reflector configurations.

The positioning system may employ various algorithms for multilateration, such as:
1. Least Squares Estimation: This method minimizes the sum of the squared differences between the measured and estimated distances to determine the most likely position.
2. Taylor Series Expansion: This approach linearizes the non-linear equations of multilateration using Taylor series expansion, allowing for iterative refinement of the position estimate.
3. Kalman Filtering: This technique may be used to combine measurements from multiple sources (e.g., reflectors and GPS) and predict the airborne system's position over time.

In some cases, the positioning system may use weighted algorithms that assign different importance to signals from various reflectors based on factors such as signal strength or reflector reliability.

The positioning system may also incorporate error correction techniques to account for potential inaccuracies in timing or reflector positions. These techniques may include:
1. Clock synchronization methods to align timing between the airborne system and reflectors.
2. Atmospheric correction models to account for signal propagation delays.
3. Statistical filtering to reduce the impact of outlier measurements.

By employing these advanced calculation methods and adaptive techniques, the positioning system may provide accurate and reliable position information for airborne systems in various operational scenarios.

The positioning system integrates multiple components to provide accurate position determination for airborne vehicles. The system may comprise an airborne component equipped with an Automatic Dependent Surveillance-Broadcast (ADS-B) transmitter and a receiver, as well as a network of ground-based reflectors.

In operation, the airborne component may transmit ADS-B signals using the ADS-B transmitter. These ADS-B signals may contain information such as the aircraft's identification, altitude, and velocity. The ADS-B signals may be broadcast at regular intervals or in response to specific triggers.

The ground-based reflectors may be configured to receive the ADS-B signals transmitted by the airborne component. Upon receiving these signals, the reflectors may process them, and generate reflection signals. In some cases, the reflectors may add additional information to the reflection signals, such as the reflector's own location or a timestamp.

After processing the received ADS-B signals, the ground-based reflectors may emit reflection signals back towards the airborne component. These reflection signals may be transmitted on a different frequency than the original ADS-B signals to avoid interference. In some cases, the reflection signals may use frequencies in the range of 960 MHz to 1215 MHz, which corresponds to the Distance Measuring Equipment (DME) frequency band.

The receiver on the airborne component may be configured to detect and process these reflection signals from the ground-based reflectors. In some implementations, the receiver may be a separate piggyback receiver mounted on the aircraft, distinct from the ADS-B transmitter.

Upon receiving the reflection signals, the airborne component may calculate the round-trip time of flight between the emission of the ADS-B signals and the reception of the reflection signals. This calculation may involve precise timing measurements and may take into account factors such as signal processing delays at the reflectors.

Using the calculated round-trip time of flight, the positioning system may determine the distance between the airborne component and each responding ground-based reflector. The system may employ multilateration techniques to calculate the position of the airborne vehicle based on these distances and the known locations of the reflectors.

In some cases, the positioning system may select a subset of the received reflection signals for position calculation, based on factors such as signal strength or geometric distribution of the reflectors. This selection process may help optimize the accuracy of the position determination.

The positioning system may integrate the calculated position information with other navigation data, such as GPS signals when available, to provide a comprehensive and robust navigation solution. In some implementations, the system may dynamically adjust its calculations based on the number and distribution of operational ground-based reflectors, ensuring consistent performance in varying environments.

By combining ADS-B technology with ground-based reflectors and sophisticated signal processing, the positioning system may provide accurate and reliable position determination for airborne vehicles, even in scenarios where traditional navigation methods may be compromised or unavailable.

### C. Computer System

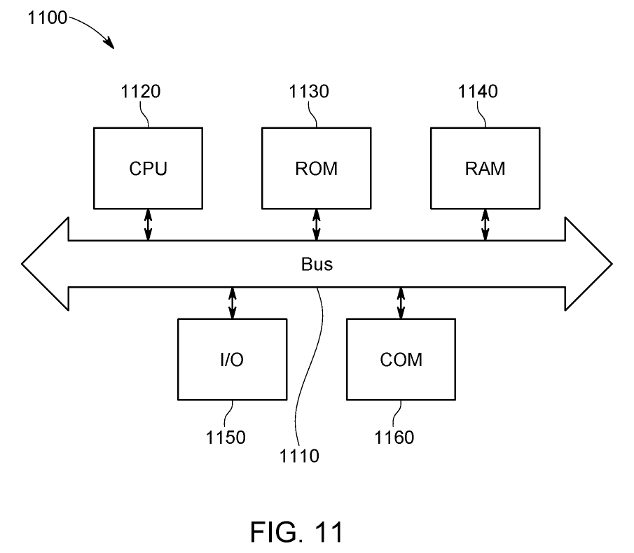

FIG. 11 depicts an example system that may execute techniques presented herein. FIG. 11 is a simplified functional block diagram of a computer that may be configured to execute techniques described herein, according to exemplary cases of the present disclosure. Specifically, the computer (or “platform” as it may not be a single physical computer infrastructure) may include a data communication interface 1160 for packet data communication. The platform may also include a central processing unit (“CPU”) 1120, in the form of one or more processors, for executing program instructions. The platform may include an internal communication bus 1110, and the platform may also include a program storage and/or a data storage for various data files to be processed and/or communicated by the platform such as ROM 1130 and RAM 1140, although the system 1100 may receive programming and data via network communications. The system 1100 also may include input and output ports 1150 to connect with input and output devices such as keyboards, mice, touchscreens, monitors, displays, etc. Of course, the various system functions may be implemented in a distributed fashion on a number of similar platforms, to distribute the processing load. Alternatively, the systems may be implemented by appropriate programming of one computer hardware platform.

The general discussion of this disclosure provides a brief, general description of a suitable computing environment in which the present disclosure may be implemented. In some cases, any of the disclosed systems, methods, and/or graphical user interfaces may be executed by or implemented by a computing system consistent with or similar to that depicted and/or explained in this disclosure. Although not required, aspects of the present disclosure are described in the context of computer-executable instructions, such as routines executed by a data processing device, e.g., a server computer, wireless device, and/or personal computer. Those skilled in the relevant art will appreciate that aspects of the present disclosure can be practiced with other communications, data processing, or computer system configurations, including: Internet appliances, hand-held devices (including personal digital assistants (“PDAs”)), wearable computers, all manner of cellular or mobile phones (including Voice over IP (“VoIP”) phones), dumb terminals, media players, gaming devices, virtual reality devices, multi-processor systems, microprocessor-based or programmable consumer electronics, set-top boxes, network PCs, mini-computers, mainframe computers, and the like. Indeed, the terms “computer,” “server,” and the like, are generally used interchangeably herein, and refer to any of the above devices and systems, as well as any data processor.

Aspects of the present disclosure may be embodied in a special purpose computer and/or data processor that is specifically programmed, configured, and/or constructed to perform one or more of the computer-executable instructions explained in detail herein. While aspects of the present disclosure, such as certain functions, are described as being performed exclusively on a single device, the present disclosure may also be practiced in distributed environments where functions or modules are shared among disparate processing devices, which are linked through a communications network, such as a Local Area Network (“LAN”), Wide Area Network (“WAN”), and/or the Internet. Similarly, techniques presented herein as involving multiple devices may be implemented in a single device. In a distributed computing environment, program modules may be located in both local and/or remote memory storage devices.

Aspects of the present disclosure may be stored and/or distributed on non-transitory computer-readable media, including magnetically or optically readable computer discs, hard-wired or preprogrammed chips (e.g., EEPROM semiconductor chips), nanotechnology memory, biological memory, or other data storage media. Alternatively, computer implemented instructions, data structures, screen displays, and other data under aspects of the present disclosure may be distributed over the Internet and/or over other networks (including wireless networks), on a propagated signal on a propagation medium (e.g., an electromagnetic wave(s), a sound wave, etc.) over a period of time, and/or they may be provided on any analog or digital network (packet switched, circuit switched, or other scheme).

Program aspects of the technology may be thought of as “products” or “articles of manufacture” typically in the form of executable code and/or associated data that is carried on or embodied in a type of machine-readable medium. “Storage” type media include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer of the mobile communication network into the computer platform of a server and/or from a server to the mobile device. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links, or the like, also may be considered as media bearing the software. As used herein, unless restricted to non-transitory, tangible “storage” media, terms such as computer or machine “readable medium” refer to any medium that participates in providing instructions to a processor for execution.

### D. Terminology

The terminology used above may be interpreted in its broadest reasonable manner, even though it is being used in conjunction with a detailed description of certain specific examples of the present disclosure. Indeed, certain terms may even be emphasized above; however, any terminology intended to be interpreted in any restricted manner will be overtly and specifically defined as such in this Detailed Description section. Both the foregoing general description and the detailed description are exemplary and explanatory only and are not restrictive of the features, as claimed.

As used herein, the terms “comprises,” “comprising,” “having,” including,” or other variations thereof, are intended to cover a non-exclusive inclusion such that a process, method, article, or apparatus that comprises a list of elements does not include only those elements, but may include other elements not expressly listed or inherent to such a process, method, article, or apparatus.

In this disclosure, relative terms, such as, for example, “about,” “substantially,” “generally,” and “approximately” are used to indicate a possible variation of ±10% in a stated value.

The term “exemplary” is used in the sense of “example” rather than “ideal.” As used herein, the singular forms “a,” “an,” and “the” include plural reference unless the context dictates otherwise.

### E. Examples

Exemplary embodiments of the systems and methods disclosed herein are described in the numbered paragraphs below.
A1. A positioning system, comprising: an airborne system equipped with an Automatic Dependent Surveillance-Broadcast (ADS-B) transmitter configured to emit ADS-B signals; a plurality of ground-based reflectors configured to receive the ADS-B signals and emit reflection signals; and a receiver on the airborne system configured to receive the reflection signals, wherein the positioning system is configured to calculate a position of the airborne system based on round-trip time of flight between emission of the ADS-B signals and reception of the reflection signals.
A2. The positioning system of A1, wherein the plurality of ground-based reflectors are configured to emit the reflection signals on a frequency different from the ADS-B signals.
A3. The positioning system of A2, wherein the frequency of the reflection signals is within a range of 960 MHz to 1215 MHz
A4. The positioning system of any of A1-A3, wherein the positioning system is further configured to calculate distances between the airborne system and each of the plurality of ground-based reflectors based on the round-trip time of flight.
A5. The positioning system of A4, wherein the positioning system is further configured to determine the position of the airborne system using multilateration based on the calculated distances.
A6. The positioning system of any of A1-A5, wherein the receiver is a piggyback receiver mounted on the airborne system separate from the ADS-B transmitter.
A7. The positioning system of any of A1-A6, wherein the positioning system is integrated into an aircraft transponder configured to process both the ADS-B signals and Global Positioning System (GPS) signals to determine the position of the airborne system.
A8. The positioning system of any of A1-A7, wherein the ground-based reflectors are configured to operate without a central server or interconnected network.
A9. The positioning system of any of A1-A8, wherein the ground-based reflectors are configured to be deployed in a distributed manner across a geographic area.
A10. The positioning system of any of A1-A9, wherein the positioning system is further configured to select a subset of the plurality of ground-based reflectors for position determination based on signal quality of the reflection signals.
A11. The positioning system of any of A1-A10, wherein the ground-based reflectors are configured to add a location and/or time stamp to the reflection signals indicating when the ADS-B signals were received at each respective transmitting ground-based reflector and a location of the respective transmitting ground-based reflector.
A12. The positioning system of any of A1-A11, wherein the positioning system is further configured to determine the position of the airborne system using a combination of the reflection signals and GPS signals when GPS signals are available.
A13. The positioning system of any of A1-A12, wherein the positioning system is further configured to dynamically adjust its position calculation based on the number of operational ground-based reflectors.
A14. A navigation system, comprising: an airborne system equipped with a position, navigation, and timing (PNT) system configured to emit first radio signals; a plurality of ground-based beacons configured to receive the first radio signals from the PNT system and emit second radio signals to the PNT system; wherein the PNT system is configured to receive the second radio signals, calculate the round-trip time of flight based on the first radio signals and the second radio signals, and determine a position of the airborne system based on the round-trip time of flight.
B1. A navigation system, comprising: an airborne system equipped with a position, navigation, and timing (PNT) system configured to emit first radio signals; a plurality of expendable ground-based beacons configured to receive the first radio signals from the PNT system and emit second radio signals to the PNT system; wherein the PNT system is configured to receive the second radio signals, calculate the round-trip time of flight based on the first radio signals and the second radio signals, and determine a position of the airborne system based on the round-trip time of flight.
B2. The navigation system of B1, wherein the expendable ground-based beacons are configured to emit the second radio signals in response to receiving a specific signal from the PNT system.
B3. The navigation system of any of B1-B2, wherein the expendable ground-based beacons are configured to self-locate upon deployment.
B4. The navigation system of any of B1-B3, wherein the expendable ground-based beacons are configured to self-locate using one or combinations of GPS, INR, signals of opportunity, coherent interferometry, and celestial timing.
B5. The navigation system of any of B1-B4, wherein the expendable ground-based beacons include an anti-tamper system configured to detect unauthorized access, movement, or tampering with the expendable ground-based beacons.
B6. The navigation system of B5, wherein the anti-tamper system is configured to erase or corrupt stored data within the beacon in response to detecting tampering.
B7. The navigation system of B5, wherein the anti-tamper system is configured to disable the beacon's radio signal emission capability upon detection of tampering.
B8. The navigation system of any of B1-B7, wherein the expendable ground-based beacons comprise a relay system configured to receive first radio signals from the PNT system and transmit the second radio signals to the PNT system.
B9. The navigation system of B8, wherein the relay system is further configured to include beacon location data in the second radio signals.
B10. The navigation system of B8, wherein the relay system is further configured to include a beacon identifier in the second radio signals.
B11. The navigation system of B10, wherein the relay system includes at least one field programmable gate array, to thereby provide consistent generation and transmission of the second radio signals.
B12. The navigation system of B11, wherein the relay system includes a plurality of field programmable gate arrays.
B13. The navigation system of B12, wherein the plurality of field programmable gate arrays are daisy chained.
B14. The navigation system of any of B1-B13, wherein the PNT system is further configured to determine the time of flight for each of the second radio signals received from the plurality of expendable ground-based beacons.
B15. The navigation system of B14, wherein the PNT system includes a time of flight (TOF) module configured to calculate the time of flight based on a time difference between emission of the first radio signals and reception of the second radio signals.
B16. The navigation system of B8, wherein the PNT system is configured to extract beacon location data and/or beacon identifiers from the second radio signals received from the expendable ground-based beacons.
B17. The navigation system of B16, wherein the beacon identifiers and the beacon location data extracted from the second radio signals are used by the PNT system to verify the authenticity of the expendable ground-based beacons and/or facilitate selection of the expendable ground-based beacons for position determination.
B18. The navigation system of B16, wherein the PNT system is configured to perform multilateration by utilizing the second radio signals received from at least three expendable ground-based beacons to determine the position of the airborne system.
B19. The navigation system of B18, wherein the PNT system includes a multilateration module configured to calculate the position of the airborne system based on the intersection of spheres, each sphere defined by the round-trip time of flight of the second radio signals and a corresponding location of a beacon from a respective expendable ground-based beacon.
B20. The navigation system of B18, wherein the PNT system is configured to determine the position of the airborne system even in the presence of signal interference by employing multilateration with the second radio signals from the expendable ground-based beacons.

Other aspects of the disclosure will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A navigation system, comprising:
an airborne system equipped with a position, navigation, and timing (PNT) system configured to emit first radio signals;
a plurality of expendable ground-based beacons configured to receive the first radio signals from the PNT system and emit second radio signals to the PNT system;
wherein the PNT system is configured to receive the second radio signals, calculate the round-trip time of flight based on the first radio signals and the second radio signals, and determine a position of the airborne system based on the round-trip time of flight.

2. The navigation system of claim 1, wherein the expendable ground-based beacons are configured to emit the second radio signals in response to receiving a specific signal from the PNT system.

3. The navigation system of claim 1, wherein the expendable ground-based beacons are configured to self-locate upon deployment.

4. The navigation system of claim 1, wherein the expendable ground-based beacons are configured to self-locate using one or combinations of GPS, INR, signals of opportunity, coherent interferometry, and celestial timing.

5. The navigation system of claim 1, wherein the expendable ground-based beacons include an anti-tamper system configured to detect unauthorized access, movement, or tampering with the expendable ground-based beacons.

6. The navigation system of claim 5, wherein the anti-tamper system is configured to erase or corrupt stored data within the beacon in response to detecting tampering.

7. The navigation system of claim 5, wherein the anti-tamper system is configured to disable the beacon's radio signal emission capability upon detection of tampering.

8. The navigation system of claim 1, wherein the expendable ground-based beacons comprise a relay system configured to receive first radio signals from the PNT system and transmit the second radio signals to the PNT system.

9. The navigation system of claim 8, wherein the relay system is further configured to include beacon location data in the second radio signals.

10. The navigation system of claim 8, wherein the relay system is further configured to include a beacon identifier in the second radio signals.

11. The navigation system of claim 10, wherein the relay system includes at least one field programmable gate array, to thereby provide consistent generation and transmission of the second radio signals.

12. The navigation system of claim 11, wherein the relay system includes a plurality of field programmable gate arrays.

13. The navigation system of claim 12, wherein the plurality of field programmable gate arrays are daisy chained.

14. The navigation system of claim 1, wherein the PNT system is further configured to determine the time of flight for each of the second radio signals received from the plurality of expendable ground-based beacons.

15. The navigation system of claim 14, wherein the PNT system includes a time of flight (TOF) module configured to calculate the time of flight based on a time difference between emission of the first radio signals and reception of the second radio signals.

16. The navigation system of claim 8, wherein the PNT system is configured to extract beacon location data and/or beacon identifiers from the second radio signals received from the expendable ground-based beacons.

17. The navigation system of claim 16, wherein the beacon identifiers and the beacon location data extracted from the second radio signals are used by the PNT system to verify the authenticity of the expendable ground-based beacons and/or facilitate selection of the expendable ground-based beacons for position determination.

18. The navigation system of claim 16, wherein the PNT system is configured to perform multilateration by utilizing the second radio signals received from at least three expendable ground-based beacons to determine the position of the airborne system.

19. The navigation system of claim 18, wherein the PNT system includes a multilateration module configured to calculate the position of the airborne system based on the intersection of spheres, each sphere defined by the round-trip time of flight of the second radio signals and a corresponding location of a beacon from a respective expendable ground-based beacon, and the PNT system is configured to determine the position of the airborne system even in the presence of signal interference by employing multilateration with the second radio signals from the expendable ground-based beacons.

20. A method for navigating an airborne system, comprising:
emitting first radio signals from a position, navigation, and timing (PNT) system onboard the airborne system;
receiving the first radio signals at a plurality of expendable ground-based beacons;
emitting second radio signals from the plurality of expendable ground-based beacons to the PNT system in response to the first radio signals;
calculating, by the PNT system, the round-trip time of flight for the first and second radio signals; and
determining, by the PNT system, the position of the airborne system based on the calculated round-trip time of flight.
